(19) United States
(12) Patent Application Publication
(10) Pub. No.: US 2009/0046641 A1
(43) Pub. Date: Feb. 19, 2009

(54) LONG TERM EVOLUTION MEDIUM ACCESS CONTROL PROCEDURES

(75) Inventors: Jin Wang, Central Islip, NY (US); Peter S. Wang, East Setauket, NY (US); Stephen E. Terry, Northport, NY (US); Ulises Olvera-Hernandez, Kirkland (CA)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL PATENT HOLDINGS, INC., Wilmington, DE (US)

(21) Appl. No.: 12/185,179

(22) Filed: Aug. 4, 2008

Related U.S. Application Data
(60) Provisional application No. 60/955,443, filed on Aug. 13, 2007.
(60) Provisional application No. 60/955,516, filed on Aug. 13, 2007.
(60) Provisional application No. 60/955,563, filed on Aug. 13, 2007.

(51) Int. Cl. H04W 4/00

(52) U.S. Cl. 370/329

(57) ABSTRACT

Several medium access control methods are disclosed. One such method is a method for requesting an uplink resource allocation. In this method, a wireless transmit/receive unit (WTRU) receives a trigger and sends an uplink resource request to a Node B based on the trigger. The WTRU receives an uplink resource assignment and prepares for an uplink transmission using the resource assignment. The WTRU then sends an acknowledgement that the uplink resource allocation was received. A wireless transmit/receive unit according to one embodiment includes a trigger device and a processor. The trigger device is configured to receive a trigger. The processor is in communication with the trigger device, and is configured to send an uplink resource request upon receipt of the trigger, receive an uplink resource assignment, and send an acknowledgement upon receipt of the uplink resource assignment.

### CROSS REFERENCE TO RELATED APPLICATIONS

This application claims the benefit of U.S. Provisional Application No. 60/955,443, filed Aug. 13, 2007; U.S. Provisional Application No. 60/955,516, filed Aug. 13, 2007; and U.S. Provisional Application No. 60/955,563, filed Aug. 13, 2007, which are incorporated by reference as if fully set forth herein.

### FIELD OF INVENTION

This application is related to wireless communications.

### BACKGROUND

The objective of Evolved UTRA and UTRAN is to develop a radio access network towards a high data rate, low latency, packet optimized system with improved system capacity and coverage. In order to achieve this, an evolution of the radio interface as well as the radio network architecture should be considered. For example, instead of using code division multiple access (CDMA) which is currently used in the Third Generation Partnership Project (3GPP), orthogonal frequency division multiple access (OFDMA) and frequency division multiple access (FDMA) are proposed air interface technologies to be used in the downlink and uplink transmissions respectively. For example, one change is to apply all packet switched service in LTE, which means that all voice calls will be made on a packet switched basis.

There are many MAC functions that need configuration and maintenance. In addition to radio resource control (RRC) control signaling, the MAC level control signaling is required. In-band control signaling is needed to exchange information between the wireless transmit/receive unit (WTRU) and the enhanced Node B (eNB) to support the necessary MAC functions such as buffer status, the transmit power, and handover measurements. It is also important to achieve a reliable transmission at MAC to MAC peer entities for packet switched data transmission and in-band signaling transmission. This entails using a control mechanism at the LTE MAC layer for the configuration and maintenance of reliable transmissions where hybrid automatic repeat request (HARQ) transmission will be used. MAC control information such as timing alignment and discontinuous reception (DRX) control are also needed in LTE.

### SUMMARY

The present application relates to a medium access control (MAC) control mechanism for resource scheduling and management of MAC-related functions such as DRX cycle in long term evolution (LTE). A new MAC layer control message; the signaling sequence chart and related criteria for resource scheduling, such as radio resource scheduling for data transmission, random access channel (RACH) resource configuration, and DRX configuration and operations; MAC maintenance, such as MAC reset and/or reconfiguration; and status inquiry as performed in LTE are proposed. Also disclosed is a new MAC control structure for reliable transmission in LTE. It proposes reliable transmission mechanisms and new MAC control PDUs and procedures. The present application also relates to procedures and signaling for DRX and measurement gap control at the LTE MAC layer. Also proposed are MAC control message contents, signaling sequence chart, parameters and triggering criteria for when DRX or measurement gap control is supported and maintained at the LTE MAC layer.

The following MAC control concepts are addressed by this disclosure: PDUs and signaling procedures for RACH resource allocation and confirmation; radio resource request and allocation; MAC function maintenance, such as MAC function and parameter reset and/or reconfiguration, MAC status inquiry, and MAC reset and/or reconfiguration; protocol data units (PDUs), parameters, triggering criteria, and signaling procedures for the hybrid automatic repeat request (HARQ) function, uplink timing alignment, DRX control, and measurement gap control. A mechanism for reliable MAC control signaling transmission is also disclosed. It is noted that although LTE is used as a specific example for the description, the principles described herein can also be applied to other communication systems, such as high speed packet access (HSPA).

### BRIEF DESCRIPTION OF THE DRAWINGS

A more detailed understanding may be had from the following description, given by way of example in conjunction with the accompanying drawings, wherein:

FIG. 1 is a flow diagram of a RACH resource allocation procedure;

FIG. 2 is a flow diagram of an uplink resource request procedure;

FIG. 3 is a flow diagram of a downlink resource allocation procedure;

FIG. 4 is a flow diagram of a resource inquiry procedure;

FIG. 5 is a flow diagram of a resource reconfiguration procedure;

FIG. 6 is a flow diagram of a HARQ reset/reconfiguration procedure;

FIG. 7 is a flow diagram of an uplink timing alignment procedure;

FIG. 8 is a flow diagram of a DRX/DTX configuration procedure;

FIG. 9 is a flow diagram of a measurement gap configuration procedure;

FIG. 10 is a flow diagram of a DRX/DTX assignment procedure;

FIG. 11 is a flow diagram of a measurement gap assignment procedure;

FIG. 12 is a flow diagram of a DRX/discontinuous transmission (DTX) inquiry procedure; and

FIG. 13 is a block diagram of a WTRU and an eNB configured to perform the methods of FIGS. 1-12.

### DETAILED DESCRIPTION

When referred to hereafter, the term “wireless transmit/receive unit (WTRU)” includes, but is not limited to, a user equipment (UE), a mobile station, a fixed or mobile subscriber unit, a pager, a cellular telephone, a personal digital assistant (PDA), a computer, or any other type of user device capable of operating in a wireless environment. When referred to hereafter, the term “base station” includes, but is not limited to, a Node B, a site controller, an access point (AP), or any other type of interfacing device capable of operating in a wireless environment.

It is noted that the PDU names and parameter names provided herein are exemplary and may vary, but the contents of the PDUs and the associated procedures are still applicable.

RACH Resource Allocation

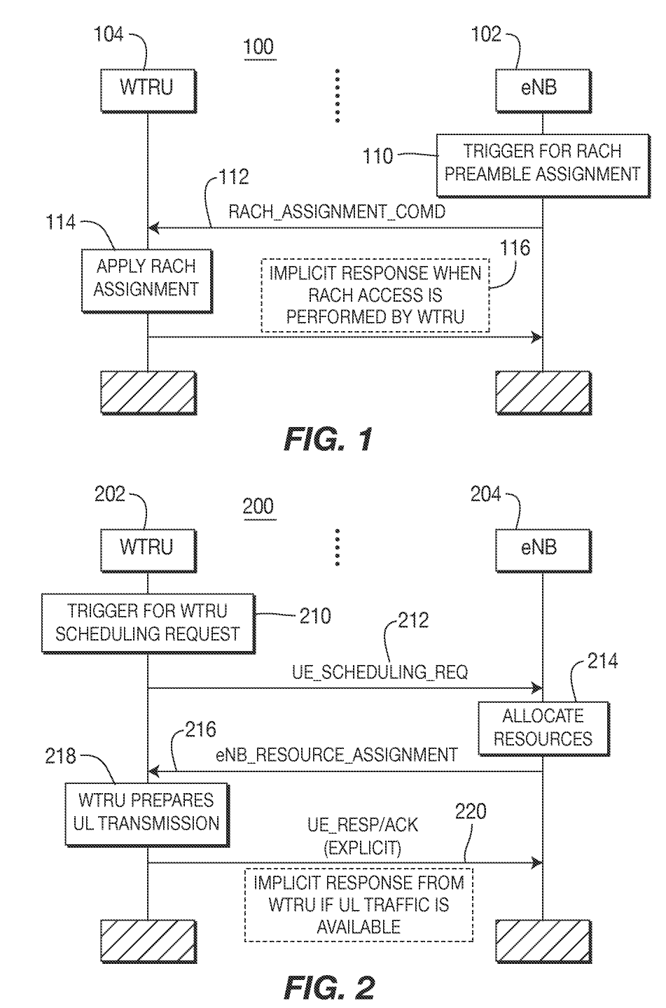

FIG. 1 is a flow diagram of a RACH resource allocation procedure 100 between an eNB 102 and a WTRU 104. The MAC control PDU for RACH resource allocation from the E-UTRAN to the WTRU is called RACH_ASSIGNMENT_COMD. Implicit confirmation from the WTRU, instead of explicit confirmation, is preferred when the WTRU uses the assigned dedicated RACH preamble for RACH access to the eNB. This MAC control PDU is used by the eNB to assign the dedicated random access resource, which includes the preamble and the access resource for a specific WTRU.

When the eNB 102 is triggered by a predefined criteria, the network makes the decision whether to assign the RACH preamble and the access resource to the WTRU 104 (step 110). The following criteria can be used to determine if the RACH_ASSIGNMENT_COMD will be initiated.

1. For initiation of a non-contention based handover (intra-eNB or inter-eNB).

2. For uplink synchronization maintenance in RRC connected mode.

3. For WTRU radio link connection re-establishment when the WTRU is in an out-of-service status.

4. For an uplink measurement report, e.g., CQI, etc.

5. The network overwrites or adds to the RACH values in the System Information Blocks which already contain the RACH information.

Once the eNB 102 makes the decision, it sends the RACH_ASSIGNMENT_COMD to the WTRU 104 which contains the allocated RACH resource (step 112). The RACH_ASSIGNMENT_COMD message includes parameters to define what information should be included when assigning the RACH access resource to the WTRU 104. These parameters define when, where, and how the WTRU 104 can access the eNB 102. The parameters include:

1. A dedicated RACH signature.

2. The preamble to be used by the WTRU in the time domain, such as the explicit RACH access subframe number, the number of subframes for which the dedicated RACH preamble is valid, and how often the RACH opportunity is available, for example every 5 ms, 10 ms, or any other values.

3. The access resource in the frequency domain, such as the sub-carrier location and a specific RACH, if more than one RACH is allocated by the E-UTRAN for dedicated random access.

4. The pattern change of the access resource; for example, the frequency hopping pattern, which allows the subsequent RACH process to change the frequency band to increase the success rate.

5. One command bit or a command field to solicit for the WTRU's action or response.

After the WTRU 104 receives the command, the WTRU 104 applies the command in the RACH access effort (step 114). The RACH access to the eNB 102 can be used as an implicit acknowledgement to eNB of the RACH preamble assignment (step 116).

The HARQ assisted reliable transmission mechanism can be applied, which can be an acknowledgement that the RACH assignment was received.

Radio Resource Allocation

The resource allocation for a WTRU can be initiated from the WTRU side when WTRU requests an uplink (UL) resource or can be initiated from the eNB side when the eNB has downlink (DL) traffic for the WTRU. The MAC control PDU and its related features for WTRU resource allocation in both directions will be described separately.

UL Resource Allocation Request

FIG. 2 is a flow diagram of an UL resource allocation request procedure 200 between a WTRU 202 and an eNB 204. There are three MAC control PDUs involved in the UL resource allocation request procedure: UE_SCHDULING_REQ (used by the WTRU 202 to request an UL radio resource), eNB_RESOURCE_ASSIGNMENT (to obtain an eNB resource assignment), and UE_RESP/ACK (for the WTRU 202 to acknowledge the assignment to the eNB 204).

When the WTRU 202 is triggered by a predefined criteria (step 210), the WTRU 202 sends the UE_SCHDULING_REQ PDU to the eNB 204 (step 212). The following criteria can be used by the WTRU 202 to determine if a scheduling request control PDU should be initiated for UL transmission: if the UL data accumulation for a transmission exceeds a predetermined rate or a predetermined threshold, upon a service priority or quality of service (QoS) change, and upon a failure of a previous scheduling request. The parameters contained in the UE_RESOURCE_REQ message can include one or more of the following: buffer occupancy (UL load), cause or service priority change, power headroom indication, channel condition (e.g., CQI), type of service, and radio access bearer identifier (RAB ID).

Once the eNB 204 receives the scheduling request, the eNB scheduler determines what resources will be allocated to the WTRU 202 (step 214). The eNB 204 sends the resource assignment to the WTRU 202 via the eNB_RESOURCE_ASSIGNMENT control PDU (step 216). The parameters contained in the eNB_RESOURCE_ASSIGNMENT message can include one or more of the following: start frame number or sub-frame number of the UL radio resource; radio resource block allocation in the frequency domain; the duration (persistency) of the radio resource allocation; channel coding; transport format combination (TFC) parameters such as the transport block (TB) size, the modulation and coding scheme (MCS), the multiplexing scheme, the power level, the beamforming scheme, etc.; and timing advance information. After the WTRU 202 successfully receives the resource assignment control PDU, the WTRU applies the resource assignment and prepares for an UL transmission (step 218).

The WTRU 202 can provide an explicit confirmation back to the eNB 204 via the UE_RESP/ACK control PDU (step 220). It is optional if the explicit RESP/ACK control PDU has to be sent. Alternatively, the acknowledgement to the eNB 204 can be implicitly conveyed through the UL traffic from the WTRU 202 applying the allocated UL radio resources.

The HARQ assisted reliable transmission mechanism can be applied, which can be acknowledgement that the UL radio resource allocation was received.

DL Resource Allocation

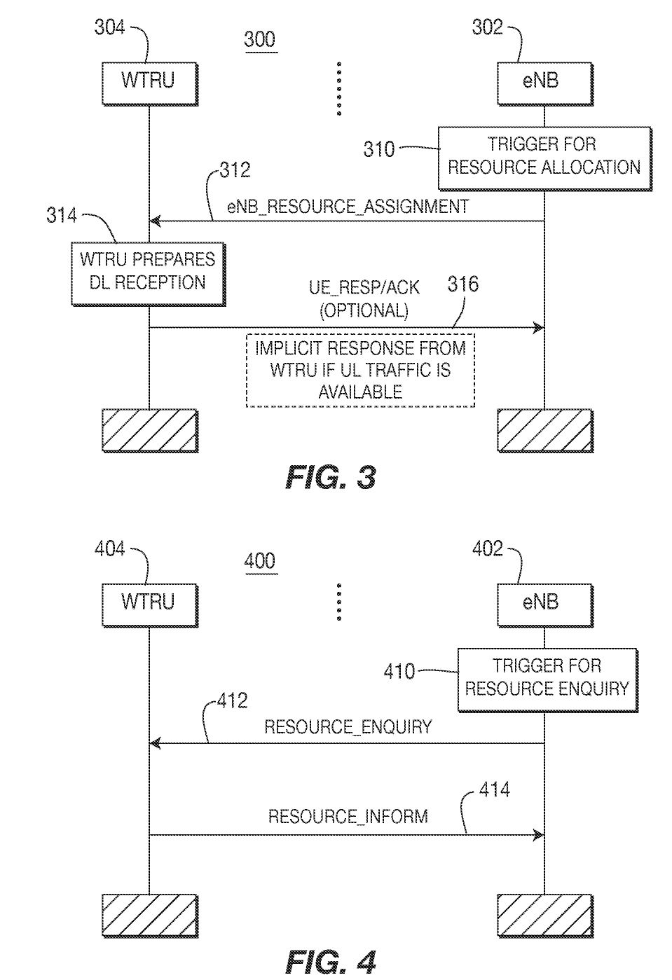

FIG. 3 is a flow diagram of a method 300 for a DL resource allocation procedure 300 from an eNB 302 to a WTRU 304. The MAC control PDUs used in connection with the DL resource allocation procedure include eNB_RESOURCE_ASSIGNMENT and UE_RESP/ACK. The eNB_RESOURCE_ASSIGNMENT PDU is used by the eNB 302 to allocate the DL radio resource to the WTRU 304. The UE_RESP/ACK PDU is used by the WTRU 304 to acknowledge receipt of the assignment to the eNB 302.

When the eNB 302 is triggered by a predefined criteria (step 310), the eNB 302 determines to allocate the DL radio resource to the WTRU 304 and sends the eNB_RESOURCE_ASSIGNMENT PDU to the WTRU 304 (step 312). The following criteria can be used by the eNB 302 to determine if the DL assignment control PDU should be initiated: DL data arrival/accumulation, data rate change, service priority or QoS change, or reception of a UE_SCHEDULING_REQ control PDU from the WTRU 304. The latter criteria is described above in connection with FIG. 2.

The parameters contained in eNB_RESOURCE_ASSIGNMENT control PDU can include or more of the following: the DL radio resource allocation, including the DL shared channel (DSCH); the start frame number or sub-frame number of the DL radio resource; the radio resource block allocation (frequency and subcarrier); the duration (persistency) in a number of frames or sub-frames; the channel coding; and the TFC parameters such as TB size, MCS, multiplexing scheme, power level, beamforming scheme, etc.

After the WTRU 304 receives the resource assignment control PDU from the eNB 302, the WTRU 304 prepares for the DL reception (step 314). The WTRU 304 then sends an explicit confirmation back to the eNB 302 via the UE_RESP/ACK control PDU (step 316). It is optional if the WTRU 304 sends the confirmation to the eNB 302 before or after preparing for the DL reception, and the steps 314 and 316 may be performed in either order.

It is also optional if the explicit response PDU has to be sent to the eNB 302. Alternatively, the acknowledgement to the eNB 302 can be implicitly conveyed through the UL traffic from the WTRU 304 by applying the allocated UL radio resource.

The HARQ assisted reliable transmission mechanism can be applied, which can serve as an acknowledgement of reception of the DL radio resource allocation from the eNB 302.

Resource Inquiry Procedure

FIG. 4 is a flow diagram of a resource inquiry procedure 400 between an eNB 402 and a WTRU 404. The resource inquiry procedure includes the MAC control PDUs RESOURCE_ENQUIRY and RESOURCE_INFORM. This procedure is performed when the E-UTRAN needs to know the resource settings on a particular WTRU. The WTRU responds to E-UTRAN's inquiry about certain or all of the WTRU's currently configured resources.

When the eNB 402 is triggered by predefined criteria (step 410), for example, the eNB 402 needs to know the resource configuration status for the WTRU 404, the eNB 402 sends the RESOURCE_ENQUIRY control PDU to the WTRU 404 (step 412). The RESOURCE_ENQUIRY PDU includes parameters relating to indications on whether the entire WTRU resource information or which part(s) of the WTRU resource information are needed.

The eNB 402 can also use certain measurement events that cause the radio resource management (RRM) entity or channel configuration entity to determine that a WTRU or a WTRU service requires additional radio resources to determine if the inquiry control PDU should be initiated. If the additional radio resources are required, then the resource inquiry control PDU is sent. It is noted that the criteria listed are exemplary and that one skilled in the art could define additional criteria to trigger the resource inquiry procedure.

After the WTRU 404 receives the resource inquiry control PDU from the eNB 402, the WTRU 404 responds with the RESOURCE_INFORM control PDU, including its current resource configuration parameters (step 414). The RESOURCE_INFORM PDU includes one or more of the following parameters: buffer occupancy, channel load, or other traffic related information; power control or power headroom value; and the currently configured transport format.

When the RESOURCE_ENQUIRY PDU is sent (step 412), the eNB 402 sets a timer for a response period to receive the RESOURCE_INFORM PDU from the WTRU 404. If the eNB 402 does not receive the RESOURCE_INFORM control PDU before the timer expires, the eNB 402 can decide whether to resend the RESOURCE_ENQUIRY control PDU to the WTRU 404. The RESOURCE_ENQUIRY control PDU can be continually resent until the expected satisfactory response is received by the eNB 402. Optionally, a limit can be placed on the number of times that the eNB 402 resends the RESOURCE_ENQUIRY control PDU.

Resource Reconfiguration

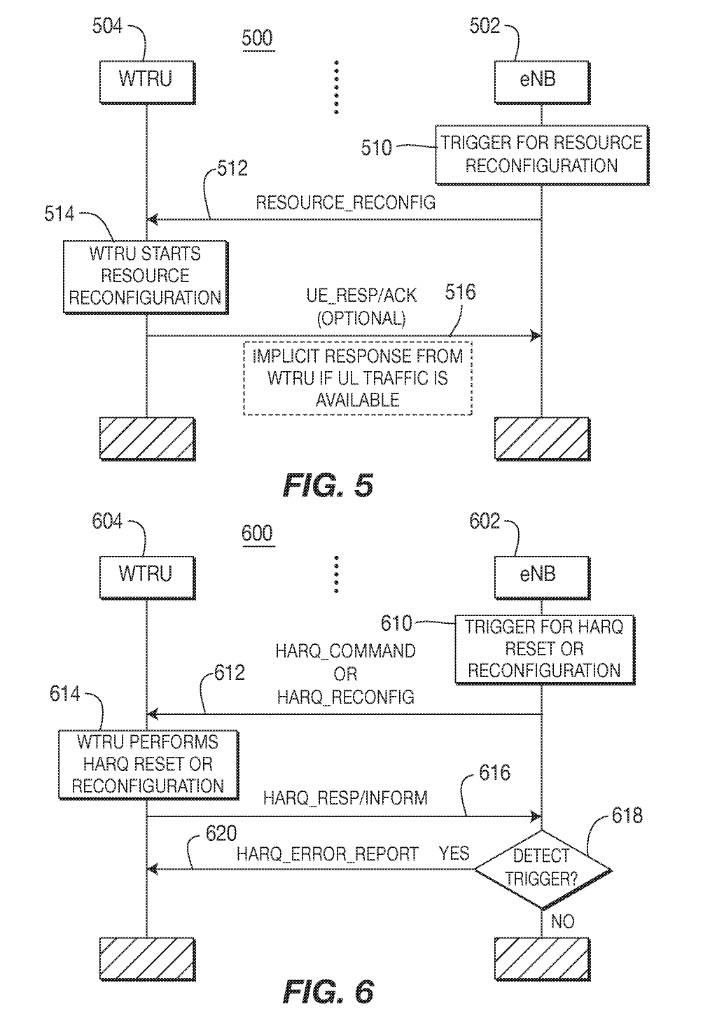

FIG. 5 is a flow diagram of a resource configuration or reconfiguration procedure 500 between an eNB 502 and a WTRU 504. The same procedure may be used for a resource configuration or a resource reconfiguration. For discussion purposes, the method 500 will be described in connection with a resource reconfiguration procedure. This procedure uses the RESOURCE_RECONFIG MAC control PDU. This control PDU is used by the eNB 502 to reconfigure certain or all of the MAC resources of the WTRU 504.

When the eNB 502 is triggered by a predefined criteria, for example due to WTRU handover, the eNB 502 determines to reconfigure the resources of the WTRU 504 (step 510). The following criteria can be used by the eNB 502 to determine if the RESOURCE_RECONFIG control PDU should be initiated and sent: a cell resource or load change; certain RRM measurement events, such as inter-cell interference level, where the WTRU 504 needs to perform a handover and the eNB 502 needs to reconfigure certain parts of the WTRU's MAC-related resources based timer; and after examining the WTRU's current resource configuration from the RESOURSE_INFORM control PDU.

The eNB 502 sends the RESOURCE_RECONFIG control PDU to the WTRU 504 (step 512). The RESOURCE_RECONFIG control PDU includes one or more of the following parameters: a profile ID to indicate to the WTRU to configure the default settings of a specified pre-configured status; a power adjustment value; a transport format change; maximum bit rate (MBR), prioritized bit rate (PBR), and/or guaranteed bit rate (GBR) related parameters; a synchronization timer value; and other scheduling information, such as timing advance information or timing adjustment offset.

After the WTRU 504 receives reconfiguration command, the WTRU 504 reconfigures its resources based on the specified parameters (step 514). Once the WTRU 504 has completed reconfiguring its resources, it sends a UE_RESP/ACK control PDU to the eNB 502 (step 516). The UE_RESP/ACK control PDU can be sent either before or after the WTRU reconfigures its resources; steps 514 and 516 may be performed in any order. Optionally, confirmation of receipt of the RESOURCE_RECONFIG control PDU can be implicitly conveyed through the UL traffic from WTRU 504.

The HARQ assisted reliable transmission mechanism can be applied, which can serve as an acknowledgement of reception of the RESOURCE_RECONFIG control PDU.

Reliable Transmission Mechanisms for LTE MAC Control PDUs

Two kinds of mechanisms for reliable LTE MAC control PDU transmission are proposed: HARQ assisted transmission and a Request/Response mechanism.

In HARQ assisted transmission, the MAC control command is sent over channels with HARQ assistance for reliable transmission. The sending HARQ process provides final transmission status, i.e., ACK or NACK (after exhausting a predetermined maximum number of retransmissions) to the sending entity, which may call for a retransmission if it is NACKed. The advantage of this mechanism is that neither a sequence number (SN) nor a timer is needed, thereby providing flexibility in terms of defining the MAC control commands and responses.

In the Request/Response mechanism, a request or command may be retransmitted if an explicit response or ACK is not received within a certain time period. The SN and a timer may be required in this approach.

The LTE MAC control PDUs can also be securely protected by an integrity protection mechanism (e.g., a simpler/smaller version).

HARQ Reset and/or Reconfiguration

FIG. 6 is a flow diagram of a HARQ reset/reconfiguration procedure 600 between an eNB 602 and a WTRU 604. The MAC control PDUs used in connection with the HARQ reset/reconfiguration procedure include: HARQ_COMMAND, HARQ_RECONFIG, HARQ_RESP/INFORM, and HARQ_ERROR_REPORT.

The HARQ_COMMAND PDU is used to start, stop, or reset a particular HARQ process. The HARQ_RECONFIG PDU is used to reconfigure a particular HARQ process. The HARQ_RESP/INFORM PDU is used to accept a HARQ reset or reconfiguration command or to inform the eNB 602 of the completion of the HARQ reset/reconfiguration process at the WTRU 604. The HARQ_RESP PDU can also indicate to the eNB 602 if the WTRU 604 accepted or rejected the HARQ reset or reconfiguration instruction. The HARQ_ERROR_REPORT PDU is used by the eNB 602 to inform the WTRU 604 of a detected HARQ error (e.g., NACK-to-ACK).

When the eNB 602 is triggered by a predefined criteria, it decides whether to reset or to reconfigure part of the HARQ process at the WTRU 604 (step 610). The triggering criteria for the HARQ_COMMAND PDU include: a handover, a system load change, a radio frequency (RF) change, a measurement result (CQI), and error reporting. The CQI result can indicate the DL channel quality, which may trigger a reconfiguration if the channel quality is “bad”. The error reporting can include a number of NACKs, which is also indicative of the channel condition. The triggering criteria for the HARQ_RECONFIG PDU include: a system load change, a change in the RF conditions, and error reporting.

Once the decision is made, the eNB 602 sends the HARQ_COMMAND PDU or the HARQ_RECONFIG PDU to the WTRU 604 (step 612). The parameters in the HARQ_COMMAND PDU include the HARQ process number and the time to reset the HARQ process. The parameters contained in the HARQ_RECONFIG PDU include: the HARQ process number, the maximum number of retransmissions, memory reconfiguration, and a map to a dataflow or service (relating to a mapping of the logical channel ID to the HARQ process).

After the WTRU 604 receives the HARQ reset or reconfiguration command from the eNB 602, the WTRU 604 performs the HARQ operation based on the command and parameters specified with the command (step 614). The WTRU 604 then sends a response (via the HARQ_RESP/INFORM PDU) to the eNB 602 that the command was received (step 616). It is optional if the response should be sent before or after the WTRU 604 performs the HARQ operations (step 614), meaning that steps 614 and 616 can be performed in any order. In one embodiment, the confirmation is sent to the eNB 602 after the HARQ parameters are applied at the WTRU 604.

If a trigger condition is detected at the eNB 602 upon receipt of the HARQ_RESP/INFORM PDU (step 618), the eNB 602 sends a HARQ_ERROR_REPORT PDU to the WTRU 604 (step 620). The triggering criteria for the HARQ_ERROR_REPORT include: NACK to ACK (meaning that a NACK can be erroneously reported as an ACK, thereby causing problems) and reaching a maximum number of retransmissions. The information in the HARQ_ERROR_REPORT PDU includes: the HARQ process number, a number of errors that occurred, a number of retransmissions that were performed, and the cause of the errors, such as memory shortage, etc.

Uplink Timing Alignment

FIG. 7 is a flow diagram of an UL timing alignment (TA) procedure 700 between a WTRU 702 and an eNB 704. The MAC control PDUs used in the UL TA procedure include: UE_SYNC_IND, TA_COMMAND, and TA_ACK. The UE_SYNC_IND PDU is used by the WTRU 702 to send a new TA request to the eNB 704. The TA_COMMAND PDU is used by the eNB 704 to indicate the TA value to be adjusted by the WTRU 702. The TA_ACK PDU is used by the WTRU 702 to acknowledge receipt of the TA value.

If the WTRU 702 is triggered by a predefined criteria (step 710), the WTRU 702 sends the TA request (via the UE_SYNC_IND PDU) to the eNB 704 (step 712). An example of the criteria includes a timer for one TA value expires and the WTRU 702 has not received the new TA value from the eNB 704. Additional criteria to determine whether the TA request should be sent include: the TA timer expires, the channel conditions change, in preparation for a handover, if there is a WTRU mobility change, and whether there is any UL traffic available.

After the eNB 704 receives the TA request from the WTRU 702, the eNB 704 performs a timing estimation process based on the received PDU and determines the appropriate TA value (step 714). The eNB 704 then sends the TA value to the WTRU 702 via the TA_COMMAND PDU (step 716). The parameters in the TA_COMMAND PDU include the TA value, the duration that this TA value can apply, and whether an explicit ACK is required.

After the WTRU 702 receives the TA_COMMAND from the eNB 704, the WTRU 702 applies the TA value in the subsequent transmissions (step 718). The WTRU 702 may optionally send a TA_ACK PDU to the eNB 704 to confirm receipt of the TA value (step 720). Alternatively, the ACK can be implicitly included inside the following UL traffic from the WTRU 702.

The HARQ assisted reliable transmission mechanism can be applied, which can serve as an ACK of reception of the DL radio resource allocation from the eNB 704.

DRX/DTX Configuration

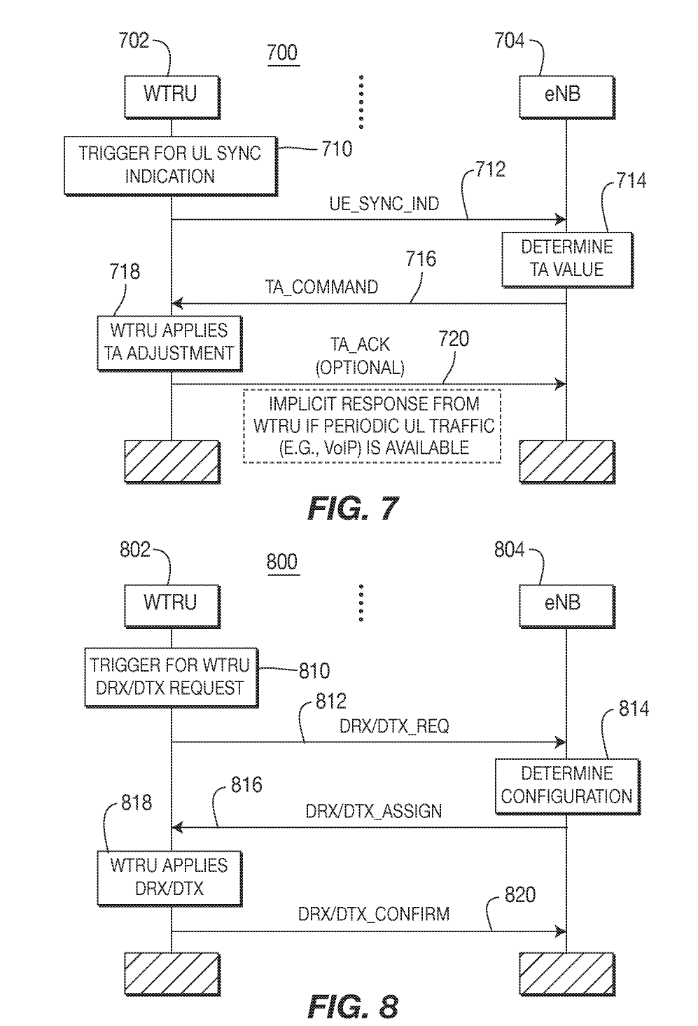

FIG. 8 is a flow diagram of a DRX/DTX configuration procedure between a WTRU 802 and an eNB 804. The MAC control PDUs involved in the DRX/DTX configuration procedure include: DRX/DTX_REQ, DRX/DTX_ASSIGN, and DRX/DTX_CONFIRM. The DRX/DTX_REQ PDU is used by the WTRU 802 to request a new DRX/DTX configuration or reconfiguration. The DRX/DTX_ASSIGN PDU is used by the eNB 804 to assign DRX/DTX operating parameters to the WTRU 802. The DRX/DTX_CONFIRM PDU is used by the WTRU 802 to confirm receipt of the assignment command.

When the WTRU 802 is triggered by a predefined criteria (step 810), the WTRU 802 decides whether to request DRX/DTX operation and sends a DRX/DTX_REQ command to the eNB 804 (step 812). The triggering criteria for sending the DRX/DTX request include whether the WTRU has a continuous DL traffic demand and whether the WTRU needs to be in a power saving mode.

In the request command, the WTRU 802 includes the necessary parameters for the eNB 804 to make the right allocation decision. The parameters contained in the DRX/DTX_REQ control PDU include: the active WTRU service types that require system bandwidth (e.g., based on their QoS), the current UL traffic load, the existing and/or requested DRX pattern and duration, the service type performed by the WTRU, and the WTRU's channel condition.

After the eNB 804 receives the DRX/DTX_REQ PDU from the WTRU 802, the eNB 804 determines the appropriate configuration based on the parameters contained in the request (step 814). The eNB 804 then signals the assignment to the WTRU 802 via the DRX/DTX_ASSIGN PDU (step 816). The parameters contained in the DRX/DRX_ASSIGN control PDU include: the number of DRX stages/levels, the stage change triggering timer/event values, and the configured DRX/DTX patterns and durations.

After the WTRU 802 receives the assignment, it applies the DRX/DTX information included in the assignment (step 818). The WTRU 802 may optionally send a confirmation to the eNB 804 indicating that the assignment command was received or that the DRX/DTX was configured as instructed (step 820). If the WTRU 802 does send the confirm PDU, it is preferred to send it after the WTRU 802 applies the parameters configured by the eNB 804.

The HARQ assisted reliable transmission mechanism can be applied, which can serve as an ACK of reception of the downlink radio resource allocation from the eNB.

Measurement Gap Configuration

FIG. 9 is a flow diagram of a measurement gap configuration procedure between a WTRU 902 and an eNB 904. The MAC control PDUs involved in the measurement gap configuration procedure include MEASUREMENT_GAP_REQ, MEASUREMENT_GAP_ASSIGN, and MEASUREMENT_GAP_CONFIRM. The MEASUREMENT_GAP_REQ PDU is used by the WTRU 902 to request a new MEASUREMENT GAP configuration/reconfiguration or to notify the eNB 904 that no gap is needed (early return). The MEASUREMENT_GAP_ASSIGN PDU is used by the eNB 904 to assign measurement gap operating parameters to the WTRU 902. The MEASUREMENT_GAP_CONFIRM PDU is used by the WTRU 902 to confirm receipt of the assignment command.

When the WTRU 902 is triggered by a predefined criteria (step 910), the WTRU 902 decides whether to request a measurement gap and sends a MEASUREMENT_GAP_REQ command to the eNB 904 (step 912). The triggering criteria for the measurement gap request include a DRX cycle change, a measurement load change upon a RF change, and a WTRU state change.

In the request command, the WTRU 902 includes the necessary parameters for the eNB 904 to make the right allocation decision, such as the current inter-frequency or inter-RAT (radio access technology) measurement load and the current DRX cycle.

After the eNB 904 receives the MEASUREMENT_GAP_REQ PDU from the WTRU 902, the eNB 904 determines the appropriate configuration based on the parameters contained in the request (step 914). The eNB 904 then signals the assignment to the WTRU 902 via the MEASUREMENT_GAP_ASSIGN PDU (step 916). The parameters in the MEASUREMENT_GAP_ASSIGN control PDU include: a measurement gap pattern, a measurement gap duration, and measurement purposes.

After the WTRU 902 receives the assignment, it applies the measurement gap information included in the assignment (step 918). The WTRU 902 may optionally send a confirmation to the eNB 904 indicating that the assignment command was received or that the measurement gap was configured as instructed (step 920). If the WTRU 902 does send the confirm PDU, it is preferred to send it after the WTRU 902 applies the parameters configured by the eNB 904.

The HARQ assisted reliable transmission mechanism can be applied, which can serve as an ACK of reception of the downlink radio resource allocation from the eNB.

DRX/DTX Assignment

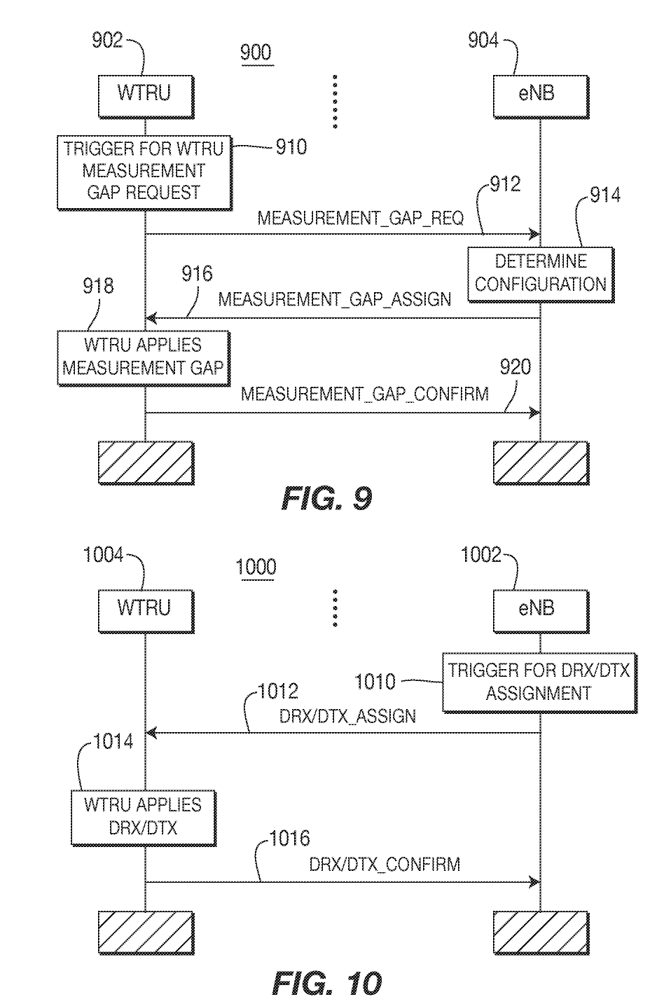

FIG. 10 is a flow diagram of a DRX/DTX assignment procedure 1000 between an eNB 1002 and a WTRU 1004. The MAC control PDUs involved in the DRX/DTX assignment procedure include DRX/DTX ASSIGN and DRX/DTX_CONFIRM. The DRX/DTX_ASSIGN PDU is used by the eNB 1002 to assign DRX/DTX operating parameters to the WTRU 1004. The DRX/DTX_CONFIRM PDU is used by the WTRU 1004 to confirm receipt of the assignment command.

After the eNB 1002 receives a predefined trigger, the eNB configures DRX/DTX operation for the WTRU 1004 (step 1010). The triggering criteria can include one of the following: the eNB 1002 directly assigns the DRX/DTX configuration to the WTRU 1004 based on the system's knowledge of the current WTRU context, the traffic conditions of a CONNECTED state WTRU, or upon receipt of a DRX_REQ PDU from the WTRU 1004.

After configuring the DRX/DTX operation, the eNB 1002 sends a DRX/DTX_ASSIGN command to the WTRU 1004 with configuration parameters (step 1012). The configuration parameters include: a number of DRX stages or levels, stage or level change triggering timer or event values, and configured DRX/DTX patterns and durations.

Upon receipt of the DRX/DTX assignment command, the WTRU 1004 applies the configuration parameters (step 1014). The WTRU 1004 may optionally send a response to the eNB 1002 that the assignment command was successfully received or that the DRX/DTX was configured as instructed (step 1016). If the WTRU 1004 sends the confirm PDU, it is preferred to send it after the WTRU 1004 applies the parameters configured by the eNB 1002.

The HARQ assisted reliable transmission mechanism can be applied, which can serve as an acknowledgement of reception of a DL radio resource allocation from the eNB.

Measurement Gap Assignment

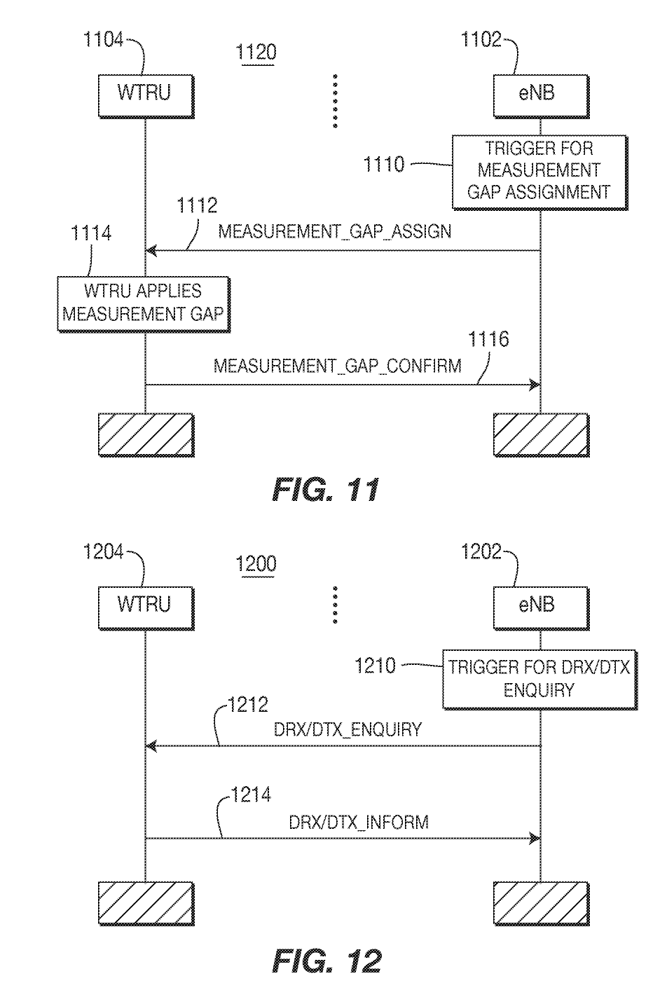

FIG. 11 is a flow diagram of a measurement gap assignment procedure 1100 between a WTRU 1102 and an eNB 1104. The MAC control PDUs involved in the measurement gap assignment procedure include: MEASUREMENT_GAP_ASSIGN and MEASUREMENT_GAP_CONFIRM. The MEASUREMENT_GAP_ASSIGN PDU is used by the eNB 1102 to assign measurement gap operating parameters to the WTRU 1104. The MEASUREMENT_GAP_CONFIRM PDU is used by the WTRU 1104 to confirm receipt of the assignment command.

After the eNB 1102 receives a predefined trigger, the eNB 1102 configures the measurement gap for the WTRU 1104 (step 1110). The triggering criteria can include one of the following: the eNB 1102 directly assigns the measurement gap configuration to the WTRU 1104 based on the system's knowledge of the current WTRU context, the traffic conditions of a CONNECTED state WTRU, or upon receipt of a MEASUREMENT_GAP_REQ PDU from the WTRU 1104.

After configuring the measurement gap, the eNB 1102 sends a MEASUREMENT_GAP_ASSIGN command to the WTRU 1104 with configuration parameters (step 1112). The configuration parameters include: a new measurement gap pattern, a duration of the measurement gap, and measurement purposes.

Upon receipt of the measurement gap assignment command, the WTRU 1104 applies the configuration parameters (step 1114). The WTRU 1104 may optionally send a response to the eNB 1102 that the assignment command was successfully received or that the measurement gap was configured as instructed (step 1116). If the WTRU 1104 sends the confirm PDU, it is preferred to send it after the WTRU 1104 applies the parameters configured by the eNB 1102.

DRX/DTX Inquiry

FIG. 12 is a flow diagram of a DRX/DTX inquiry procedure 1200 between an eNB 1202 and a WTRU 1204. The MAC control PDUs used in the inquiry procedure include DRX/DTX_ENQUIRY and DRX/DTX_INFORM. The DRX/DTX_ENQUIRY PDU is used by the eNB 1202 to inquire about the WTRU's current DRX or DTX configuration. The DRX/DTX_INFORM PDU is used by the WTRU 1204 to inform the eNB 1202 about its current DRX or DTX configuration.

When the eNB 1202 is triggered by a predefined criteria (step 1210), for example if the eNB 1202 needs to know the DRX/DTX configuration status the WTRU 1204, the eNB 1202 sends the DRX/DTX_ENQUIRY control PDU to the WTRU 1204 (step 1212). The triggering criteria can also include certain measurement events that cause the RRM or channel configuration entity to inquire about the DRX/DTX configuration. The DRX/DTX_ENQUIRY control PDU includes the specific DRX/DTX values that the eNB 1202 want to know about.

After the WTRU 1204 receives the DRX/DTX inquiry control PDU from the eNB 1202, the WTRU 1204 can respond to the eNB 1202 by sending the DRX/DTX_INFORM control PDU with its current resource configuration parameters (step 1214). The resource configuration parameters include: a number of DRX/DTX stages or levels, stage or level change triggering timer or event values, and configured DRX/DTX patterns and durations.

When the eNB 1202 sends the DRX/DTX_ENQUIRY control PDU to the WTRU 1204, a response timer is started. If the eNB 1202 does not receive the DRX/DTX_INFORM control PDU from the WTRU 1204 before the response timer expires, the eNB 1202 can decide whether to resend the DRX/DTX_ENQUIRY control PDU until the satisfactory response is received. Optionally, a limit can be placed on the number of times that the eNB 1202 resends the DRX/DTX_ENQUIRY control PDU.

Apparatus

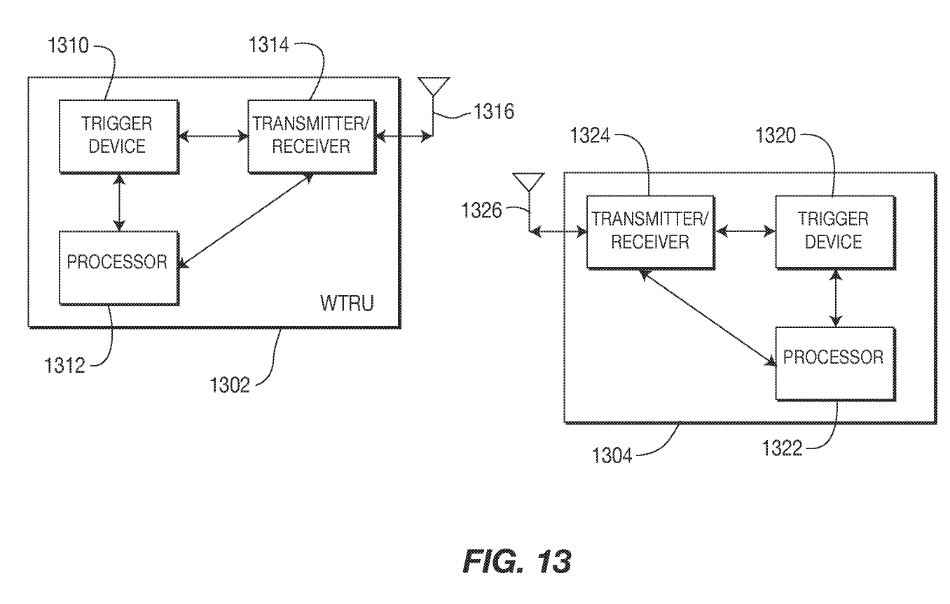

FIG. 13 is a block diagram of a WTRU 1302 and an eNB 1304 configured to perform the methods described above. The WTRU 1302 includes a trigger device 1310, a processor 1312 in communication with the trigger device 1310, a transmitter/receiver 1314 in communication with the trigger device 1310 and the processor 1312, and an antenna 1316 in communication with the transmitter/receiver 1314. The eNB 1304 includes a trigger device 1320, a processor 1322 in communication with the trigger device 1320, a transmitter/receiver 1324 in communication with the trigger device 1320 and the processor 1322, and an antenna 1326 in communication with the transmitter/receiver 1324.

In operation, the trigger device 1310 receives information from other components of the WTRU 1302 (not shown in FIG. 13) generates triggers for the WTRU to send out control PDUs. The trigger device 1310 coordinates with the processor 1312 and the transmitter/receiver 1314 in determining when to send out a control PDU. The processor 1312 is responsible for processing incoming PDUs, including tasks such as resource assignments and configurations, responding to inquiries from the eNB 1304, and sending responses or ACKs to the eNB 1304.

Similarly, in operation, the trigger device 1320 receives information from other components of the eNB 1304 (not shown in FIG. 13) generates triggers for the eNB to send out control PDUs. The trigger device 1320 coordinates with the processor 1322 and the transmitter/receiver 1324 in determining when to send out a control PDU. The processor 1322 is responsible for processing incoming PDUs, including tasks such as receiving requests from the WTRU 1302, determining resource assignments and configurations, receiving responses and ACKs from the WTRU 1302, and processing the responses and ACKs to detect errors.

Although features and elements are described above in particular combinations, each feature or element can be used alone without the other features and elements or in various combinations with or without other features and elements. The methods or flow charts provided herein may be implemented in a computer program, software, or firmware incorporated in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) or Ultra Wide Band (UWB) module.

What is claimed is:

1. A method for requesting an uplink resource assignment, comprising:
receiving a trigger;
sending an uplink resource request;
receiving an uplink resource assignment;
preparing for an uplink transmission using the resource assignment; and
sending an acknowledgement that the resource assignment was received.

2. The method according to claim 1, wherein the trigger is at least one of: a level of uplink data accumulation, a service priority change, a quality of service change, and failure of a previous scheduling request.

3. The method according to claim 1, wherein the resource request includes at least one of: buffer occupancy, service priority change, power headroom indication, channel condition, type of service, and radio access bearer identifier.

4. The method according to claim 1, wherein the resource assignment includes at least one of: start frame number of the uplink radio resource, start sub-frame number of the uplink radio resource, radio resource block allocation, duration of the radio resource allocation, channel coding, transport format combination parameters, and timing advance information.

5. The method according to claim 1, wherein the acknowledgement is an explicit acknowledgement message.

6. The method according to claim 1, wherein the acknowledgement is implicit when the uplink transmission is made.

7. A wireless transmit/receive unit (WTRU), comprising:
a trigger device configured to receive a trigger; and
a processor in communication with the trigger device, the processor configured to:
send an uplink resource request upon receipt of the trigger;
receive an uplink resource assignment; and
send an acknowledgement upon receipt of the uplink resource assignment.

8. The WTRU according to claim 7, wherein the trigger is at least one of: a level of uplink data accumulation, a service priority change, a quality of service change, and failure of a previous scheduling request.

9. The WTRU according to claim 7, wherein the resource request includes at least one of: buffer occupancy, service priority change, power headroom indication, channel condition, type of service, and radio access bearer identifier.

10. The WTRU according to claim 7, wherein the resource assignment includes at least one of: start frame number of the uplink radio resource, start sub-frame number of the uplink radio resource, radio resource block allocation, duration of the radio resource allocation, channel coding, transport format combination parameters, and timing advance information.

11. The WTRU according to claim 7, wherein the acknowledgement is an explicit acknowledgement message.

12. The WTRU according to claim 7, wherein the acknowledgement is implicit when an uplink transmission is made.

13. A method for allocating uplink resources, comprising:
receiving an uplink resource request;
allocating uplink resources based on the request;
sending an uplink resource assignment; and
receiving a response indicating that the resource assignment was received.

14. The method according to claim 13, wherein the resource request includes at least one of: buffer occupancy, service priority change, power headroom indication, channel condition, type of service, and radio access bearer identifier.

15. The method according to claim 13, wherein the resource assignment includes at least one of: start frame number of the uplink radio resource, start sub-frame number of the uplink radio resource, radio resource block allocation, duration of the radio resource allocation, channel coding, transport format combination parameters, and timing advance information.

16. The method according to claim 13, wherein the response is an explicit acknowledgement message.

17. The method according to claim 13, wherein the response is implicit when an uplink transmission is received.

18. A method for allocating downlink resources, comprising:
receiving a trigger;
allocating downlink resources;
sending a downlink resource assignment to a wireless transmit/receive unit (WTRU); and
receiving a response from the WTRU indicating that the resource assignment was received.

19. The method according to claim 18, wherein the trigger includes at least one of: downlink data accumulation, a data rate change, a service priority change, a quality of service change, and receipt of a scheduling request.

20. The method according to claim 18, wherein the resource assignment includes at least one of: a downlink shared channel, a start frame number of the downlink radio resource, a start sub-frame number of the downlink radio resource, a radio resource block allocation, a duration of the downlink resource, channel coding information, and transport format combination parameters.

21. The method according to claim 18, wherein the response is an explicit acknowledgement message.

22. The method according to claim 18, wherein the response is implicit if there is subsequent uplink traffic from the WTRU.

23. A method for using a downlink resource allocation, comprising:
receiving a downlink resource assignment at a wireless transmit/receive unit (WTRU);
preparing for downlink reception; and
sending a response that the resource assignment was received.

24. The method according to claim 23, wherein the resource assignment includes at least one of: a downlink shared channel, a start frame number of the downlink radio resource, a start sub-frame number of the downlink radio resource, a radio resource block allocation, a duration of the downlink resource, channel coding information, and transport format combination parameters.

25. The method according to claim 23, wherein the response is an explicit acknowledgement message.

26. The method according to claim 23, wherein the response is implicit if there is subsequent uplink traffic from the WTRU.

27. A method for configuring resources, comprising:
receiving a trigger;
sending a resource configuration message to a wireless transmit/receive unit (WTRU); and
receiving a response from the WTRU indicating that the resources were configured.

28. The method according to claim 27, wherein the trigger includes at least one of: a cell resource change, a cell load change, a handover, and upon receipt of a current resource configuration of the WTRU.

29. The method according to claim 27, wherein the resource configuration message includes at least one of: a profile identifier corresponding to a preconfigured status, a power adjustment value, a transport format change, bit rate related parameters, a synchronization timer value, timing advance information, and timing adjustment offset information.

30. The method according to claim 27, wherein the response is an explicit acknowledgement message.

31. The method according to claim 27, wherein the response is implicit if there is subsequent uplink traffic from the WTRU.

32. A method for configuring resources, comprising:
receiving a resource configuration message at a wireless transmit/receive unit (WTRU);
performing a resource configuration based on the configuration message;
sending a response indicating that the resources were configured.

33. The method according to claim 32, wherein the resource configuration message includes at least one of: a profile identifier corresponding to a preconfigured status, a power adjustment value, a transport format change, bit rate related parameters, a synchronization timer value, timing advance information, and timing adjustment offset information.

34. The method according to claim 32, wherein the response is an explicit acknowledgement message.

35. The method according to claim 32, wherein the response is implicit if there is subsequent uplink traffic from the WTRU.

36. A method for reconfiguring a hybrid automatic repeat request (HARQ) process, comprising:
receiving a command trigger;
sending a HARQ reconfiguration command;
receiving a response that the command was received;
determining if the response includes an error trigger; and
sending an error report if the response includes the error trigger.

37. The method according to claim 36, wherein the command trigger includes at least one of: a handover, a system load change, a radio frequency change, a channel quality indicator, and error reporting.

38. The method according to claim 36, wherein the reconfiguration command includes at least one of: a HARQ process number, a length of time to reset the HARQ process, a maximum number of retransmissions, memory reconfiguration information, and a mapping of a logical channel identifier to the HARQ process.

39. The method according to claim 36, wherein the error trigger includes at least one of: a negative acknowledgement being erroneously reported as an acknowledgement and reaching a maximum number of retransmissions.

40. The method according to claim 36, wherein the error report includes at least one of: the HARQ process number, a number of errors that occurred, a number of retransmissions that were performed, and a cause of the errors.

41. A method for reconfiguring a hybrid automatic repeat request (HARQ) process, comprising:
receiving a HARQ reconfiguration command;
performing the HARQ reconfiguration command; and
sending a response that the command was received.

42. The method according to claim 41, wherein the reconfiguration command includes at least one of: a HARQ process number, a length of time to reset the HARQ process, a maximum number of retransmissions, memory reconfiguration information, and a mapping of a logical channel identifier to the HARQ process.

43. The method according to claim 41, wherein the response includes an error trigger, the error trigger including at least one of: a negative acknowledgement being erroneously reported as an acknowledgement and reaching a maximum number of retransmissions.

44. The method according to claim 43, further comprising:
receiving an error report, the error report including at least one of: the HARQ process number, a number of errors that occurred, a number of retransmissions that were performed, and a cause of the errors.

45. A method for uplink timing alignment, comprising:
receiving a trigger;
sending an uplink timing alignment request;
receiving a timing alignment command, including a timing alignment value;
applying the timing alignment value;
sending a response that the timing alignment command was received.

46. The method according to claim 45, wherein the trigger includes at least one of: a timing alignment timer expires, a change in channel conditions, a handover, a wireless transmit/receive unit mobility change, and whether there is any uplink traffic available.

47. The method according to claim 45, wherein the timing alignment command includes at least one of: the timing alignment value, a duration that the timing alignment value is valid, and whether an explicit acknowledgement is required.

48. The method according to claim 45, wherein the response includes an explicit acknowledgement that the timing adjustment command was received.

49. The method according to claim 45, wherein the response is implicit if there is subsequent uplink traffic.

50. A method for uplink timing alignment, comprising:
receiving an uplink timing alignment request;
performing a timing estimation process based on the timing alignment request to determine a timing alignment value;
sending a timing alignment command, including the timing alignment value; and
receiving a response that the timing alignment command was received.

51. The method according to claim 50, wherein the timing alignment command includes at least one of: the timing alignment value, a duration that the timing alignment value is valid, and whether an explicit acknowledgement is required.

52. The method according to claim 50, wherein the response is an explicit acknowledgement that the timing adjustment command was received.

53. The method according to claim 50, wherein the response is implicit if there is subsequent uplink traffic.

54. A method for configuring discontinuous reception (DRX) and discontinuous transmission (DTX) at a wireless transmit/receive unit (WTRU), comprising:
receiving a trigger;
sending a DRX/DTX request;
receiving a DRX/DTX assignment; and
applying the DRX/DTX assignment.

55. The method according to claim 54, wherein the trigger includes at least one of: whether the WTRU has a continuous downlink traffic demand and whether the WTRU needs to be in a power saving mode.

56. The method according to claim 54, wherein the request includes at least one of: active WTRU service types, a current uplink traffic load, an existing DRX pattern and duration, a service type performed by the WTRU, and current channel conditions.

57. The method according to claim 54, wherein the assignment includes at least one of: a number of DRX/DTX stages, a number of DRX/DTX levels, a stage change triggering timer value, a stage change triggering event value, one or more DRX/DTX patterns, and a duration for each pattern.

58. The method according to claim 54, further comprising:
sending a DRX/DTX confirmation to indicate that the DRX/DTX assignment was received.

59. A method for configuring discontinuous reception (DRX) and discontinuous transmission (DTX), comprising:
receiving a DRX/DTX request from a wireless transmit/receive unit (WTRU);
determining a DRX/DTX configuration based on the request; and
sending a DRX/DTX assignment to the WTRU.

60. The method according to claim 59, wherein the request includes at least one of: active WTRU service types, a current uplink traffic load, an existing DRX pattern and duration, a service type performed by the WTRU, and current channel conditions.

61. The method according to claim 59, wherein the assignment includes at least one of: a number of DRX/DTX stages, a number of DRX/DTX levels, a stage change triggering timer value, a stage change triggering event value, one or more DRX/DTX patterns, and a duration for each pattern.

62. The method according to claim 59, further comprising:
receiving a DRX/DTX confirmation from the WTRU to indicate that the DRX/DTX assignment was received.

63. A method for allocating a random access channel (RACH) resource, comprising:
receiving a trigger;
sending a resource allocation to a wireless transmit/receive unit (WTRU); and
receiving a response from the WTRU, whereby the response provides an indication that the resource allocation was applied.

64. The method according to claim 63, wherein the trigger is at least one of:
initiation of a non-contention based handover, uplink synchronization maintenance, radio link connection re-establishment, an uplink measurement report, and changes to the RACH values in a system information block.

65. The method according to claim 63, wherein the resource allocation includes at least one of: a dedicated RACH signature, a preamble for the time domain, an access resource for the frequency domain, a pattern change of the resource, and a response command field.

66. The method according to claim 65, wherein the preamble for the time domain includes at least one of: a RACH access subframe number, a number of subframes that the preamble is valid, and a frequency of how often the RACH opportunity is available.

67. The method according to claim 65, wherein the access resource for the frequency domain includes at least one of: a sub-carrier location and a specific RACH if more than one RACH is allocated.

68. The method according to claim 65, wherein the pattern change of the resource includes a frequency hopping pattern.

69. The method according to claim 63, wherein the response is implicit when the WTRU accesses the RACH.

70. A method for using a random access channel (RACH) resource allocation, comprising:
receiving a RACH resource allocation, the resource allocation including access parameters;
applying the access parameters; and
accessing the RACH, whereby an implicit acknowledgement is sent, indicating that the resource allocation was received.

71. The method according to claim 70, wherein the access parameters include at least one of: a dedicated RACH signature, a preamble for the time domain, an access resource for the frequency domain, a pattern change of the resource, and a response command field.

72. The method according to claim 71, wherein the preamble for the time domain includes at least one of: a RACH access subframe number, a number of subframes that the preamble is valid, and a frequency of how often the RACH opportunity is available.

73. The method according to claim 71, wherein the access resource for the frequency domain includes at least one of: a sub-carrier location and a specific RACH if more than one RACH is allocated.

74. The method according to claim 71, wherein the pattern change of the resource includes a frequency hopping pattern.

75. A method for performing a resource inquiry, comprising:
receiving a trigger;
sending a resource inquiry to a wireless transmit/receive unit (WTRU); and
receiving resource information from the WTRU.

76. The method according to claim 75, wherein the trigger includes at least one of: a resource configuration status of the WTRU is needed and certain measurement events.

77. The method according to claim 75, wherein the resource inquiry includes an indication of what WTRU resource information is needed.

78. The method according to claim 75, wherein the resource information includes at least one of: buffer occupancy, channel load, power control, power headroom value, and a currently configured transport format.

79. The method according to claim 75, further comprising:
starting a response timer when the resource inquiry is sent; and
resending the resource inquiry if the resource information is not received from the WTRU before the response timer expires.

80. The method according to claim 79, wherein the resource inquiry is resent up to a predetermined number of times.

81. A method for providing resource information, comprising:
receiving a resource inquiry from a Node B, the resource inquiry including requested information; and
providing the requested information to the Node B.

82. A method for discontinuous reception (DRX) and discontinuous transmission (DTX) assignment, comprising:
receiving a trigger; and
sending a DRX/DTX assignment to a wireless transmit/receive unit (WTRU).

83. The method according to claim 82, wherein the trigger includes at least one of: a current WTRU context, traffic conditions of the WTRU, receipt of a DRX/DTX request from the WTRU.

84. The method according to claim 83, wherein the assignment includes at least one of: a number of DRX/DTX stages, a number of DRX/DTX levels, a stage change triggering timer value, a stage change triggering event value, one or more DRX/DTX patterns, and a duration for each pattern.

85. The method according to claim 82, further comprising:
receiving a confirmation from the WTRU that the DRX/DTX assignment was received.

86. A method for applying a discontinuous reception (DRX) and discontinuous transmission (DTX) assignment, comprising:
receiving the DRX/DTX assignment, the assignment including at least one of: a number of DRX/DTX stages, a number of DRX/DTX levels, a stage change triggering timer value, a stage change triggering event value, one or more DRX/DTX patterns, and a duration for each pattern; and
applying the DRX/DTX assignment.

87. The method according to claim 86, further comprising:
sending a confirmation that the DRX/DTX assignment was received.

88. A method for measurement gap configuration at a wireless transmit/receive unit (WTRU), comprising:
receiving a trigger;
sending a measurement gap request;
receiving a measurement gap assignment; and
applying the measurement gap assignment.

89. The method according to claim 88, wherein the trigger includes at least one of: a discontinuous reception cycle change, a measurement load change upon a radio frequency change, and a WTRU state change.

90. The method according to claim 88, wherein the request includes at least one of: a current inter-frequency measurement load, a current inter-radio access technology measurement load, and a current discontinuous reception cycle.

91. The method according to claim 88, wherein the assignment includes at least one of: a measurement gap pattern, a measurement gap duration, and measurement purposes.

92. The method according to claim 88, further comprising:
sending a confirmation that the measurement gap assignment was received.

93. A method for measurement gap configuration, comprising:
receiving a measurement gap request from a wireless transmit/receive unit (WTRU);
determining a measurement gap configuration based on the request; and
sending a measurement gap assignment to the WTRU, the assignment including the measurement gap configuration.

94. The method according to claim 93, wherein the request includes at least one of: a current inter-frequency measurement load, a current inter-radio access technology measurement load, and a current discontinuous reception cycle.

95. The method according to claim 93, wherein the assignment includes at least one of: a measurement gap pattern, a measurement gap duration, and measurement purposes.

96. The method according to claim 93, further comprising:
receiving a confirmation from the WTRU that the measurement gap assignment was received.

97. A method for measurement gap assignment, comprising:
receiving a trigger; and
sending a measurement gap assignment to a wireless transmit/receive unit (WTRU).

98. The method according to claim 97, wherein the trigger includes at least one of: a current WTRU context, traffic conditions of the WTRU, and receipt of a measurement gap request from the WTRU.

99. The method according to claim 97, wherein the assignment includes at least one of: a measurement gap pattern, a measurement gap duration, and measurement purposes.

100. The method according to claim 97, further comprising:
receiving a confirmation from the WTRU that the measurement gap assignment was received.

101. A method for applying a measurement gap assignment, comprising:
receiving the measurement gap assignment, the assignment including at least one of: a measurement gap pattern, a measurement gap duration, and measurement purposes; and
applying the measurement gap assignment.

102. The method according to claim 101, further comprising:
sending a confirmation that the measurement gap assignment was received.

103. A method for discontinuous reception (DRX) and discontinuous transmission (DTX) inquiry by a Node B, comprising:
receiving a trigger;
sending an inquiry to a wireless transmit/receive unit (WTRU); and
receiving a response from the WTRU.

104. The method according to claim 103, wherein the trigger includes at least one of: current DRX/DTX configuration information for the WTRU is not available and a predetermined measurement event.

105. The method according to claim 103, wherein the inquiry includes specific DRX/DTX values that are needed by the Node B.

106. The method according to claim 103, wherein the response includes at least one of: a number of DRX/DTX stages, a number of DRX/DTX levels, a stage change triggering timer value, a stage change triggering event value, one or more DRX/DTX patterns, and a duration for each pattern.

107. The method according to claim 103, further comprising:
starting a response timer when the inquiry is sent; and
resending the inquiry if no response is received from the WTRU before the response timer expires.

108. The method according to claim 107, wherein the inquiry is resent up to a predetermined number of times.
